(19) United States
(12) Patent Application Publication
(10) Pub. No.: US 2010/0301005 A1
(43) Pub. Date: Dec. 2, 2010

(54) Method of Manufacturing an Electrical Circuit on a Substrate

(76) Inventor: Peter L.J. Nilsson, Bohus (SE)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/474,598

(22) Filed: May 29, 2009

(51) Int. Cl. H01B 13/00

(52) U.S. Cl. 216/18

(57) ABSTRACT

Electrical components, e.g., radiators, are made by a method comprising the steps of (1) providing a substrate, e.g., a polymeric film, having a first facial side that has a metal coating, e.g., copper, and a second facial side that does not have a metal coating; (2) applying an etch-resist to the metal coating to define a trace; (3) etching from the substrate the metal coating not covered by the etch-resist; (4) removing the etch-resist from the metal coating; and (5) plating, e.g., electroless plating, the uncovered metal coating with a plating material comprising at least one of silver, gold, and nickel.

### FIELD OF THE INVENTION

The present invention relates generally to a method of manufacturing an electrical circuit or component on a substrate. In one aspect, the invention relates to the production of flexible printed circuits while in another aspect, the invention relates to a method of making radiators useful in the construction of cell phones, computers and the like.

### BACKGROUND OF THE INVENTION

Various types of electrical circuits are manufactured through the use of an etch-resist printing method. This method involves various steps which are described below. Etch-resist printing may be used on both rigid and flexible substrates. When used with a flexible substrate the circuit is called a flexible printed circuit (FPC). FPC's offer the benefit of providing a relatively thin and flat profile that is bendable and can be manipulated easily without fracturing. This enables FPC's to be used in applications that have shape and size restrictions, e.g., computers, cell phones and the like. In addition, FPC's offer a reduced weight over printed circuits using heavier, rigid substrates which add to their portability.

An FPC can include one or more of various electrical circuit components, such as a radiator. To maximize manufacturing efficiency, many copies of one component are typically manufactured on a single substrate and then later separated for individual use. To manufacture an FPC that includes one or more components, various steps must be performed. First, a metal, e.g., copper is applied to a flexible substrate. Then etch-resist is printed on top of the metal to outline one or more components, a contact strip, and robber/buzz bars. The robber/buzz bars interconnect the components with the contact strip and will be used to facilitate an electroplating process by providing a path for electricity to all of the metal on the substrate, as discussed below. After the etch-resist has been applied, the uncovered or exposed metal is stripped away using an etching process. This process leaves only the etch-resist covered portions of metal on the substrate. The etch-resist is then stripped away revealing the remaining metal. Solder-mask is then applied to large areas of the substrate to substantially cover the components and robber bars with the exception of component contact spots. This often requires the use of excessive solder-mask. The contact spots are later used to electrically couple the component to another component. The solder-mask protects the metal from oxidation and limits the sections of metal that will be electroplated.

Traditionally, the electroplating process is performed by exposing the substrate to a solution containing positively charged nickel and gold ions. Electricity is applied to the contact strip creating a negative charge at the contact spots. The opposite charges of the nickel and gold ions and the metal, e.g., copper, create an attraction that couples the ions with the exposed metal of the contact spots. Further, the absolute thickness of the nickel and gold plating is often greater than ideally necessary due to irregularities (high and low points) in the thickness of the plating along the surface of the metal. Without compensation the low points along the surface would otherwise fall below desired specification for minimum plating thickness.

Alter electroplating an adhesive is applied to the facial side of the substrate opposite the facial side of the substrate that is carrying the components, and the substrate is then cut. Due to the existence of the metal contact strip and the robber bars, the substrate requires a die tool, such as a flatbed die tool, to cut the substrate into individual components or strips of substrate containing one or more components. Further, the robber bars and contact strip may contribute to the waste of raw materials as they occupy space on the substrate that may have been used to manufacture additional components.

In addition, the components often require one or more holes to be created for mounting or weight reduction. These holes are punched through the substrate and adhesive, and can require both male and female-type cutting tools. These tools are often difficult and expensive to obtain and are inflexible when the size or shape of a hole requires modification. Due to the excessive lead time to obtain these tools, a spare tool is typically required to ensure that production is not impeded should a tool break. In addition these tools require frequent servicing to re-sharpen their blades.

### BRIEF SUMMARY OF THE INVENTION

The present invention in at least some embodiments relates to a method of manufacturing an electrical component that comprises a trace, the method comprising the steps of:

A. Providing a substrate having a first facial side that has a metal coating and a second facial side that does not have a metal coating;

B. Applying etch-resist to the metal coating to define the trace of the electrical component;

C. Etching from the substrate the metal coating not covered by the etch-resist;

D. Removing the etch-resist from the metal coating; and

E. Plating the uncovered metal coating with a plating material that comprises at least one of silver, gold, and nickel.

In one embodiment the electrical component is a radiator.

In one embodiment the method also includes applying an adhesive to the second facial side of the substrate and cutting through at least the substrate and, optionally, the adhesive with a laser.

In one embodiment the method includes cutting holes through the substrate and, optionally, the adhesive.

In one embodiment a plurality of radiators is manufactured on a substrate to which the etch-resist is applied in a matrix comprising at least two rows.

In one embodiment the substrate is cut into strips that are collected onto at least one roll.

In one embodiment the invention is a method of manufacturing radiators on a polymeric film, the radiators comprising a trace, the method comprising the steps of:

A. Providing a flexible, polymeric film having a first facial side that has a copper metal coating and a second facial side that does not have a metal coating;

B. Applying etch-resist to the copper metal coating to define a plurality of discreet traces arrayed in a matrix comprising at least two rows;

C. Etching from the film the copper metal coating not covered by the etch-resist;

D. Removing the etch-resist from the copper metal coating;

E. Electrolessly plating the uncovered copper metal coating with a substantially uniform thickness of plating material that comprises at least one of silver, gold and nickel;

F. Applying a double-sided tape to the second facial side of the polymeric film; and

G. Cutting the polymeric film and double-sided tape to form strips each of which includes at least one row of radiators.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. Like reference numerals are used to indicate like components.

FIG. 1 is an exemplary flow diagram of a method of manufacturing radiators on a substrate.

FIG. 2A is a top view of a substrate with a metal coating.

FIG. 2B is a cross-sectional view of FIG. 2A at line A-A.

FIG. 3A is a schematic view of the substrate of FIG. 2A with multiple etch-resists on the metal coating defining the traces of exemplary radiators.

FIG. 3B is a close-up view of FIG. 3A.

FIG. 3C is a cross-sectional view of FIG. 3B at line B-B.

FIG. 4A is a schematic view of FIG. 3A with the uncovered metal coating substantially etched away.

FIG. 4B is a close-up view of FIG. 4A.

FIG. 4C is a cross-sectional view of FIG. 4B at line C-C.

FIG. 4D is a close-up view of FIG. 4B at D-D.

FIG. 5A is a schematic view of FIG. 4A with the etch-resist removed.

FIG. 5B is a close-up view of FIG. 5A.

FIG. 5C a cross-sectional view of FIG. 5B at line E-E.

FIG. 6A is a schematic view of FIG. 5A with the uncovered metal coating plated with a plating material.

FIG. 6B is a close-up view of FIG. 6A.

FIG. 6C is a cross-sectional view of FIG. 6B at line F-F.

FIG. 6D is a side view of 6B at line G-G.

FIG. 6E is a close-up perspective view of FIG. 6B at H-H.

FIG. 7A is a schematic view of the FIG. 6A showing exemplary strip, hole and radiator cut marks.

FIG. 7B is a close-up view of FIG. 7A.

FIG. 8 is an exploded view of FIG. 7B.

### DETAILED DESCRIPTION OF THE PREFERRED EMBODIMENT

The numerical ranges in this disclosure are approximate, and thus may include values outside of the range unless otherwise indicated. Numerical ranges include all values from and including the lower and the upper values, in increments of one unit. As an example, if a compositional, physical or other property, such as, for example, substrate thickness, metal coating thickness, etc. is from 1 to 100, it is intended that all individual values, such as 1, 2.6, 3, etc., and sub ranges, such as 10 to 30, 40 to 60, etc., are expressly enumerated. In addition, one unit is considered to be 0.0001, 0.001, 0.01 or 0.1, as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the thickness of the substrate and the metal coating.

“Flexible” and like terms mean capable of being substantially bent with minimal force and without breaking or creasing.

“Rigid” and like terms mean non-flexible, stiff or unyielding, requiring greater than a minimal force to bend, and likely to break or crease under such bending force.

“Radiator” and like terms mean an electrical component that is capable of radiating an electromagnetic field in response to Radio Frequency (RF) voltage or current that is applied or induced to it, the radiator being capable of operating as both a transmitter and/or a receiver.

“Trace” and like terms mean the conductive pathway of an electrical circuit or component.

“Hole” and like terms mean an aperture or passage that extends completely through the substrate and, optionally, the adhesive.

“Etching” and like terms mean the process of removing a portion of unprotected metal coating from the substrate by exposing the unprotected coating to an etching agent, such as an acid, for example, ferric chloride in combination with ammonium persulfate.

“Plating” and like terms mean the deposition of a metal onto a conductive surface.

“Electroplating” and like terms mean that an ionic metal is supplied with electrons to form a non-ionic coating on a substrate. One common system involves a chemical solution with the ionic form of the metal, an anode (positively charged) which may consist of the metal being plated (a soluble anode) or an insoluble anode (e.g., carbon, platinum, titanium, lead, or steel), and finally, a cathode (negatively charged) where electrons are supplied to produce a film of non-ionic metal.

“Electroless plating”, “chemical plating”, “auto-catalytic plating” and like terms mean a non-galvanic type of plating method that involves several simultaneous reactions in an aqueous solution which occur without the use of external electrical power. In one embodiment, the reaction is accomplished when hydrogen is released by a reducing agent, e.g., sodium hypophosphite, and oxidized thus producing a negative charge on the surface of a substrate.

Although the following description of the invention is in the context of a method for manufacturing a radiator as a component of a flexible printed circuit, from a copper coated polymeric film, and chemically plating at least a portion of the trace of the radiator with silver, the method may be applied to other components utilizing other metal coatings on other substrates and plated with other materials. Various items of equipment that may be used to facilitate the manufacturing process, such as lasers and the like, have been selectively omitted to simplify the drawings.

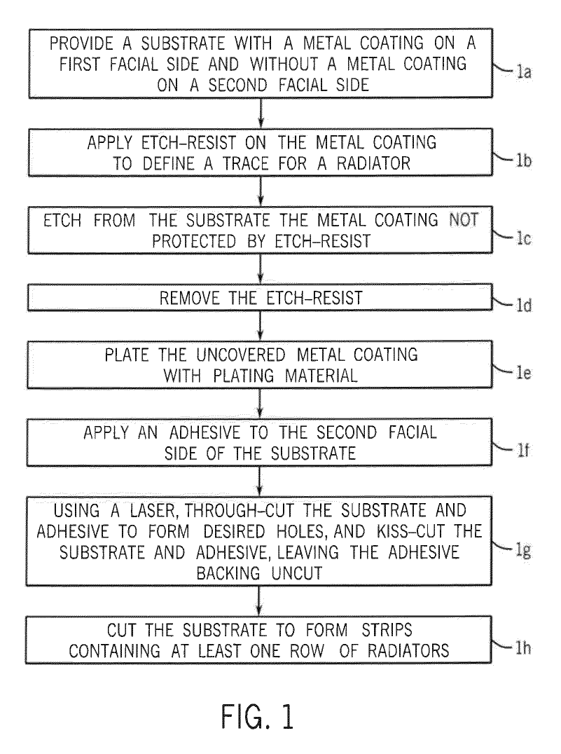

FIG. 1 is a flow diagram depicting exemplary method steps 1a-1h which is discussed in greater detail below. These method steps may be performed in more than one order, and the method may comprise more or fewer steps.

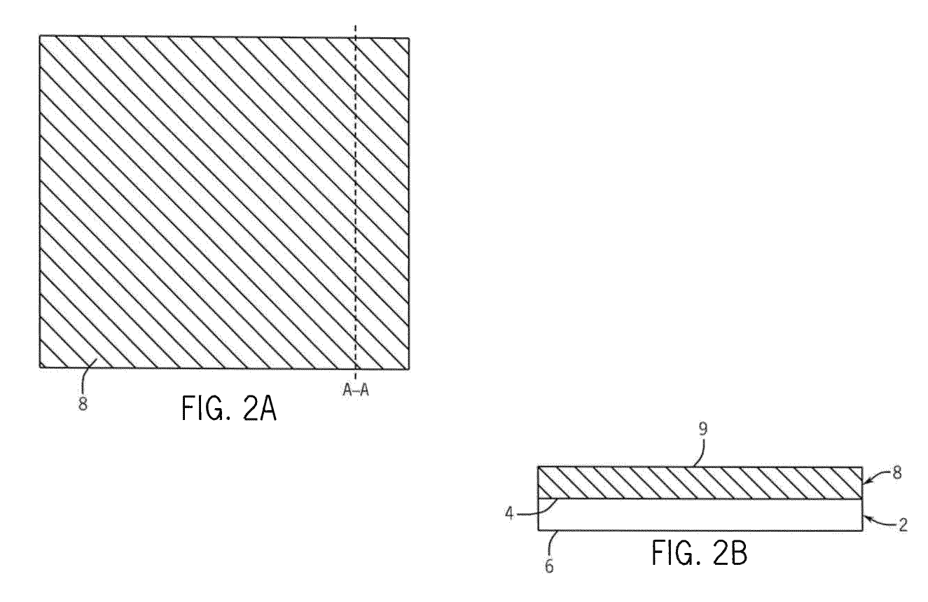

FIGS. 2A and 2B depict an exemplary substrate, namely polymeric film 2 having first facial side 4 and second facial side 6. Metal coating 8 is applied to the surface of first facial side 4 and comprises a top surface 9. Film 2 is comprised of a flexible material, such as polyethylene terephthalate, although other types of polymeric film and substrates may be used. In at least one embodiment, film 2 has a thickness of 40 to 60 microns, typically 50 microns, although other embodiments may differ in thickness. In addition, other embodiments may include a substrate comprised of a rigid material, such as synthetic resin bonded paper or fiberglass, although other rigid materials may be used. Further, although coating 8 in the present embodiment is a copper metal coating having a thickness of 10 to 30 microns, typically 20 microns, other types of coatings, such as zinc and aluminum, can also be used.

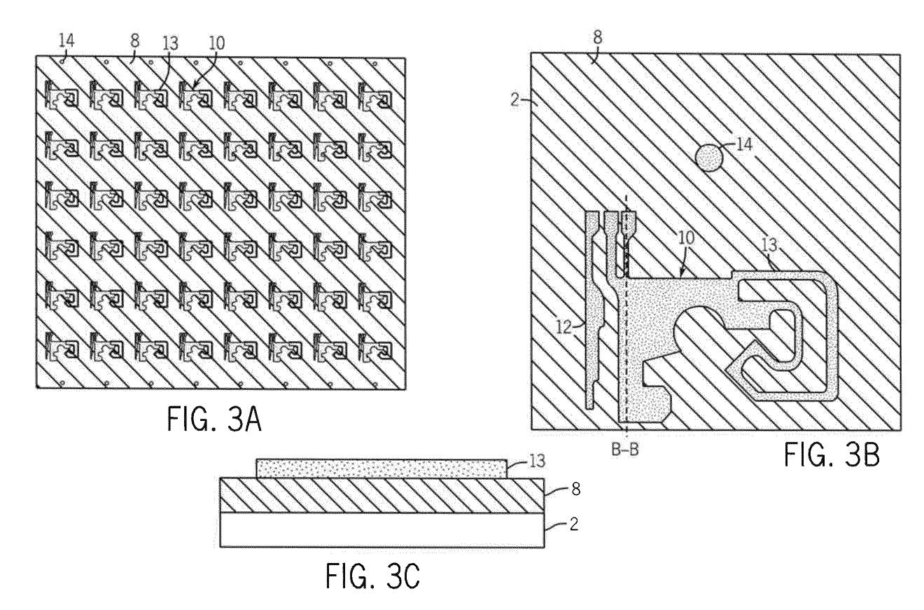

More particularly, FIG. 2B is a cross-sectional view of FIG. 2A at line A-A, depicting coating 8 layered on first facial side 4 of film 2. Film 2 serves as a base for supporting coating 8. A circuit trace, such as for a radiator (as seen in FIG. 3A), is formed from at least a portion of coating 8 and as such, it is affixed or otherwise adhered to film 2.

As seen in FIG. 3A, etch-resist 13 is applied to metal coating 8 in the pattern or configuration of a matrix or array of discreet circuit traces 10. In addition, other portions of coating 8 may be covered with etch-resist to form other markings on the metal coating, e.g., register marks 14 which can be used as reference points during the manufacturing process. Etch-resist 13 may be applied on coating 8 by one or more of various methods, such as screen-printing and photo etching using a flatbed or cylinder screen machine that utilizes a charge coupled device. The etch-resist can also be applied using a rotary screen or an inkjet. Etch-resist 13 comprises a material that is impervious to the chemicals used in the etching and plating processes, and these materials are well known and commercially available.

Further referencing FIGS. 3A and 3B, although the methods described may be used to manufacture a plurality of radiators on film 2, the methods may also be used to manufacture a single radiator on a single sheet of film. FIG. 3A depicts a plurality of traces 10 on film 2 in a matrix configuration. Additionally, FIG. 3C depicts a cross-sectional view of FIG. 3B at line B-B, showing film 2, coating 8 and etch-resist 13.

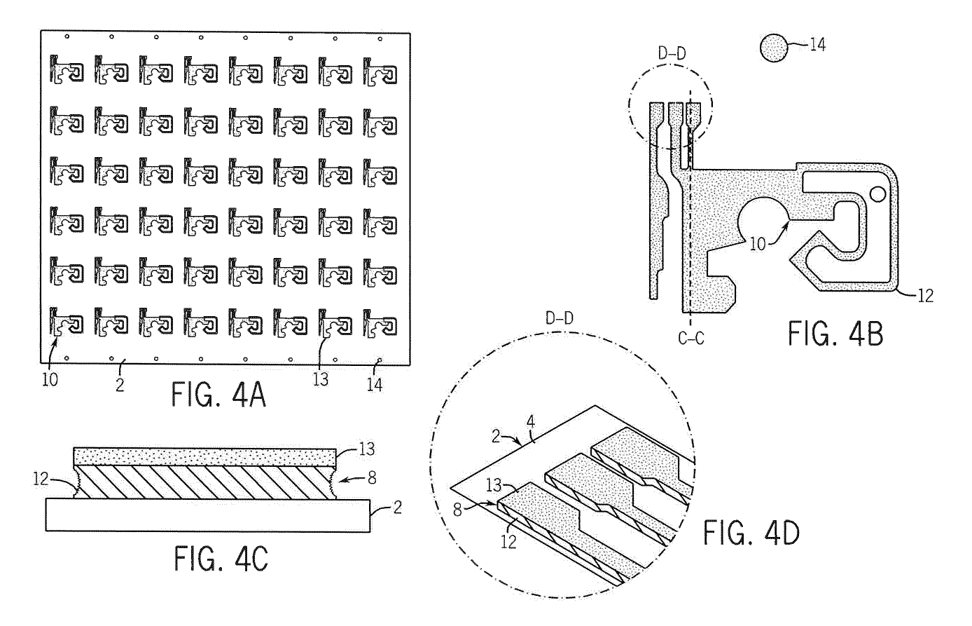

Referring to FIGS. 4A, 4B, 4C and 4D, after metal coating 8 has been covered by etch-resist 13, coating 8 is removed from film 2 in an etching process. This process generally results in imperfect coating edge 12 along the etch-resist such that at places the metal extends beyond the etch-resist edge (e.g., a convex extension or bulge extending out from the etch-resist edge, not shown) while at other places metal is removed from beneath the etch-resist edge (e.g. a concave extension or cavity extending beneath the etch-resist edge, also not shown). These edge imperfections are due, in part, to the etch-resist itself, i.e., the etch-resist edge is typically not straight and smooth (at least on a microscopic level) and the action of the etching agent will simply follow this edge. In addition the etching agent will, to a limited extent, work its way under the etch-resist until the etching agent is removed from the surface of the metal coating, typically by washing. The edge imperfection and/or loss of metal beneath the etch-resist can diminish the radio frequency performance of the radiator.

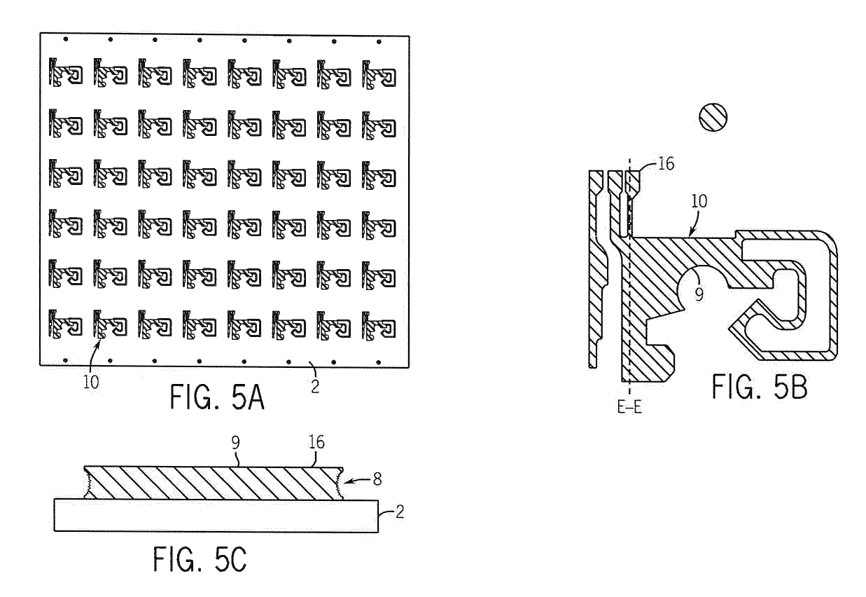

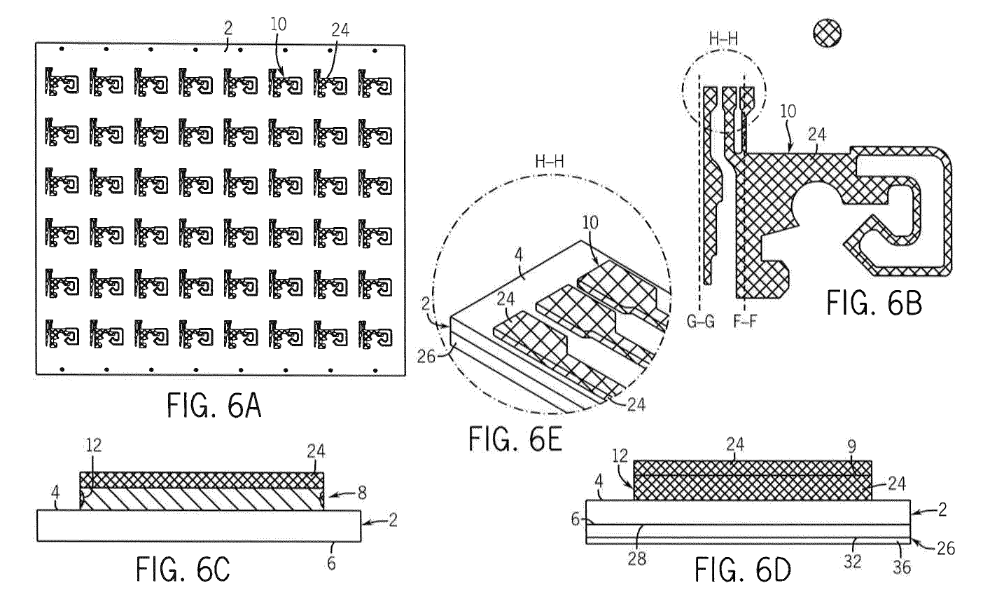

Referring to FIGS. 5A-5C, the etch-resist that covered traces 10 is stripped away to expose the remaining metal coating 8 which includes a coating top surface 9 and edge surface 12 (as seen in FIGS. 6D and 6E). Coating top surface 9 further includes one or more contact spots 16 used to electrically couple trace 10 to another circuit or component.

At this point top surface 9 and edge 12 are ready for plating. These surfaces are electrolessly plated by contacting them with a plating solution containing plating material 24 that adheres to metal coating 8. The plating material 24 is typically a metal, more typically at least one of gold, silver and nickel. In one embodiment plating material 24 comprises a metal that has a high density that effectively blocks the oxidation of the metal, e.g., copper, that is located beneath it while maintaining a high level of conductivity, such as the silver used in the ESM-200 autocatalytic electroless silver-plating process by Polymer Kompositer of Gothenburg, Sweden. This particular plating process provides a dense silver coating that is relatively uniform in thickness across the surface of which it is applied. The thickness of the plated material will vary with the electrical component although the thickness is typically at least 0.1 micron, more typically 0.2 to 3 microns, particularly for microwave applications. In one embodiment, the thickness of the plated material is not greater than 2 microns.

As shown in FIGS. 6A-6D, after sufficient exposure, plating material 24 adheres to the top surfaces 9 and edge surfaces 12. The plating protects the coating top surface 9 from corrosion while retaining electrical conductivity at contact spots 16. Further, the plating protects edge surfaces 12 from corrosion and fills in the protrusions and depressions with plating material 24. As the electrical losses increase at high frequencies when a current is forced to flow over irregularities, smoothing out the irregularities along edge surfaces 12 improves the RF properties of the radiators (i.e. increased transmitting capabilities, a lower loss value and potentially lower power consumption). In at least one embodiment, plating material 24 is adhered to at least one of top surface 9 and edge surface 12 by the use of an electroplating process.

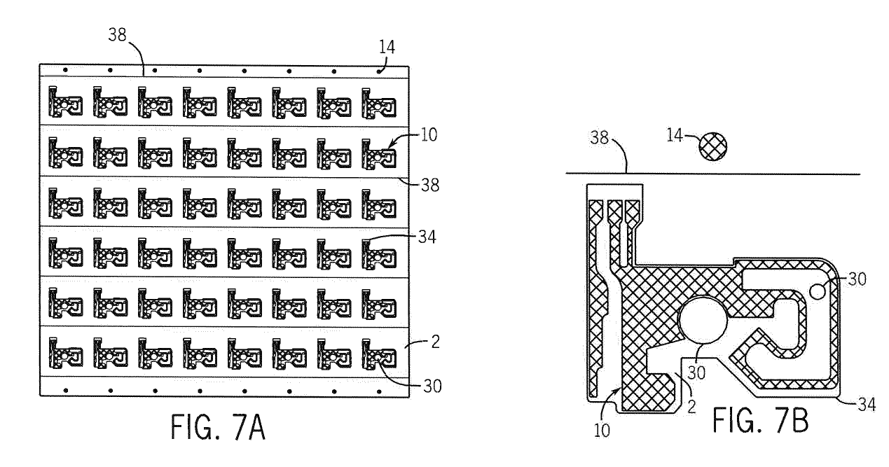

Upon completion of plating, an adhesive, such as double-sided tape 26, is applied to second facial side 6 of film 2, as seen in FIGS. 6D and 6E. Tape 26 includes first facial side 28 which is applied to film 2 and second facial side 32 that remains protected by backing 36. After tape 26 has been applied, various cuts are performed. Referring to FIGS. 7A and 7B, the areas to be cut are represented by hole cut marks 30, radiator cut marks 34, and strip cut marks 38. These cut marks represent a pre-defined cutting route that is programmed into a controller to operate a laser that will perform cuts as described below. Register marks 14 may serve as a reference guide for the laser. In addition, an automated or manually operated die tool may be configured to provide the necessary cuts. Further, the cut marks may be printed on film 2 to serve as a visual guide for a non-automated cutting tool.

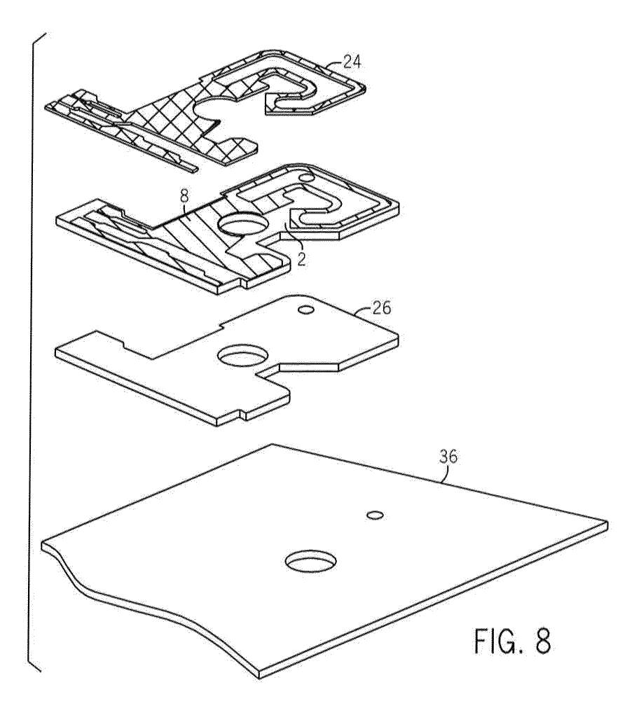

Hole cut marks 30 identify the locations where holes arc to be cut. Radiator cut marks 34 identify a template for the overall radiator. Radiator cut marks 34 are not through-cut, but rather kiss-cut (i.e. the cut is made through film 2 and substantially through tape 26, although backing 36 of the tape 26 is not cut). The kiss-cut allows for radiators to be maintained in a sheet or roll form until removal is desired. Maintaining the radiators on a sheet or roll provides a convenient method of transport for use in an automated radiator installation process. FIG. 8 provides an exploded view of the radiator after the hole cut marks 30 and radiator cut marks 34 have been completed. In addition, referring again to FIGS. 7A and 7B, strip cut marks 38 may be through-cut to separate radiators on film 2 into strips containing one or more radiators. At this point the radiators may be adhered to a molded plastic carrier (not shown) using tape 26 to form an antenna (not shown). The carrier and the radiator may then be mounted on a printed circuit board or directly to a portion of one of various types of devices, such as a cellular telephone, a laptop computer, and a Global Positioning System (OPS).

In the present embodiment, a laser (not shown) such as a CO₂ laser or a UV laser, is the primary or sole cutting tool. The manufacturing process described above provides a matrix of radiators that is suitable for laser cutting, as metal coating 8 does not extend beyond the perimeter of each radiator. As such, superfluous coating, such as robber bars or contact strips, that would otherwise interfere with the use of a laser is eliminated. Further, the use of a laser allows the locations of cuts identified by cut marks 30, 34, 38 to be modified merely by adjusting the cutting route programmed into a controller. This provides substantial versatility in the manufacturing process, as it precludes the need for fixed die tools in the cutting process. The use of fixed die tools requires a new die tool to be manufactured having a new configuration each time the cutting parameters change.

Further, strip cut marks 38 may be cut using a laser as no robber bars or contact strips exist. Alternatively, a non-laser cutting tool, such as a cutting blade that is adjustable based on the desired strip size, may be used. The non-laser cutting tool provides a sufficient cutting function for strip cut marks 38 as the strip cut is generally linear and may be accommodated by a single tool for various strip sizes.

The present invention is not limited to the embodiments and illustrations, but includes modified forms of those embodiments including portions of the embodiments and combinations of elements of different embodiments as come within the scope of the following claims.

We claim:

1. A method of manufacturing an electrical component that comprises a trace that comprises a contact spot, the method comprising the steps of:
A. Providing a substrate having a first facial side that has a metal coating and a second facial side that does not have a metal coating;
B. Applying etch-resist to the metal coating to define the trace of the electrical component;
C. Etching from the substrate the metal coating not covered by the etch-resist;
D. Removing the etch-resist from the metal coating; and
E. Plating the uncovered metal coating with a plating material that comprises at least one of silver, gold, and nickel.

2. The method of claim 1 in which the plating is electroless plating.

3. The method of claim 2 in which the electroless plating is autocatalytic electroless silver plating.

4. The method of claim 2 in which the etch-resist is applied to the metal coating by at least one of screen printing and photo-etching.

5. The method of claim 4 comprising the further step of applying an adhesive lo the second facial side of the substrate.

6. The method of claim 5 further comprising the further step of cutting at least the substrate with a laser after the uncovered metal is plated.

7. The method of claim 6 in which the etch-resist is applied to the metal coating of the substrate to define a plurality of traces arrayed in a matrix comprising at least two rows.

8. The method of claim 7 in which the substrate is cut into strips with each strip including at least one electrical component.

9. The method of claim 7 in which the substrate is flexible.

10. The method of claim 9 in which the electrical component is a radiator.

11. The method of claim 10 in which the substrate is a polymeric film.

12. The method of claim 11 in which the substrate is a polyethylene terephthalate film, the metal coating is copper, and the plating material is applied in a substantially uniform thickness to the uncovered metal coating.

13. The method of claim 12 in which the film has a thickness of 40 to 60 microns, the metal coating has a thickness of 10 to 30 microns, and the thickness of the plated material is at least 0.1 micron.

14. The method of claim 13 in which the adhesive is a double-sided tape.

15. The method of claim 14 in which the cutting of the film with a laser includes cutting holes through the film and substrate.

16. The method of claim 15 in which the thickness of the plated material is 0.2 to 3 microns.

17. The method of claim 2 in which the substrate is rigid.

18. A method of manufacturing radiators on a polymeric film, the radiators comprising a trace, the method comprising the steps of:
A. Providing a flexible, polymeric film having a first facial 'side that has a copper metal coating and a second facial side that does not have a metal coating;
B. Applying etch-resist to the copper metal coating to define a plurality of discreet traces arrayed in a matrix comprising at least two rows;
C. Etching from the film the copper metal coating not covered by the etch-resist;
D. Removing the etch-resist from the copper metal coating;
E. Electrolessly plating the uncovered copper metal coating with a substantially uniform thickness of plating material that comprises at least one of silver, gold and nickel;
F. Applying a double-sided tape to the second facial side of the polymeric film; and
G. Cutting the polymeric film and double-sided tape to form strips each of which includes at least one row of radiators.

19. The method of claim 18 in which the polymeric film is a polyethylene terephthalate film that has a thickness of 40 to 60 microns, the copper metal coating has a thickness of 10 to 30 microns, and the thickness of the plated material is not greater than 2 microns.

20. The method of claim 19 in which plating material comprises silver.
